(19) United States
(12) Patent Application Publication
(10) Pub. No.: US 2007/0100947 A1
(43) Pub. Date: May 3, 2007

(54) Method and apparatus for determining whether an email message is ready for transmission

(76) Inventors: Yen-Fu Chen, Austin, TX (US); John Hans Handy-Bosma, Cedar Park, TX (US); Mei Yang Selvage, Pocatello, ID (US); Alan Richard Tannenbaum, Austin, TX (US); Keith Raymond Walker, Austin, TX (US)

Correspondence Address: IBM CORP (YA);C/O YEE & ASSOCIATES PC, P.O. BOX 802333, DALLAS, TX, 75380, US

(21) Appl. No.: 11/264,807

(22) Filed: Nov. 1, 2005

(51) Int. Cl. G06F 15/16

(52) U.S. Cl. 709/206

(57) ABSTRACT

A computer implemented method, apparatus, and computer usable program code to analyze an email message using a policy to form a result in response to detecting a request to send an email message. A determination is made as to whether the result indicates that the email message is complete. An alert is generated if a determination is present that indicates that the email message is incomplete.

### BACKGROUND OF THE INVENTION

1. Field of the Invention

The present invention relates generally to an improved data processing system and in particular to a method and apparatus for processing email messages. Still more particularly, the present invention relates to a computer implemented method, apparatus, and computer usable program code for determining whether an email message is complete and ready for transmission.

2. Description of the Related Art

The Internet is a global network of computers and networks joined together by gateways that handle data transfer and the conversion of messages from a protocol of a sending network to a protocol used by a receiving network. On the Internet, any computer may communicate with any other computer. Information between computers travels over the Internet through a variety of languages also referred to as protocols. The set of protocols used on the Internet is called the transmission control protocol/Internet protocol (TCP/IP).

The Internet has revolutionized communications and commerce as well as being a source of information and entertainment. For many users, email is a widely used format to communicate over the Internet. It is commonplace for users to send email messages to others users through the Internet.

The use of email messages is commonplace for personal and business use. Email messages are used by individuals to keep in touch with and communicate with other users. Additionally, email messages provide a medium to collaborate and exchange documents. Oftentimes, a user will attach a file to an email message. The file is typically intended for the recipient to review and oftentimes comment or edit. These files may take various forms, such as documents and spreadsheets. Other types of files that may be exchanged include images and video.

An occasional problem that occurs when a user sends an email message is if the user forgets to perform a task that should have been performed prior to the transmission of the email message. For example, most people have sent or received emails promising an attachment, but the attachment is absent from the email message. Similarly, many users have asked a recipient to contact them at a particular phone number or stop by at an address, but then have forgotten to include the information in the email message.

This type of problem can lead to embarrassment or a reduction in perceived professionalism or care. Additionally, by forgetting to include information or attach a file, the recipient may have to remind the sender that the information has been forgotten. At that point, the sender is required to resend another email message with the needed information. Further, when an email message is sent to multiple recipients, the consequences are multiplied.

Thus, it would be advantageous to have an improved computer implemented method, apparatus, and computer usable program code to prevent the transmission of an email message before the email message is complete and ready to send.

### SUMMARY OF THE INVENTION

The present invention provides a computer implemented method, apparatus, and computer usable program code to analyze an email message using a policy to form a result in response to detecting a request to send an email message. A determination is made as to whether the result indicates that the email message is complete. An alert is generated if a determination is present that indicates that the email message is incomplete.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is a block diagram of a data processing system shown in which aspects of the present invention may be implemented;

FIG. 3 is a diagram illustrating an exemplary electronic mail messaging system in accordance with an illustrative embodiment of the present invention;

FIG. 4 is a diagram illustrating components used to define incomplete email messages in accordance with an illustrative embodiment of the present invention;

FIG. 5 is a diagram illustrating a graphical user interface for an email client in accordance with an illustrative embodiment of the present invention;

FIG. 6 is a diagram of a template in accordance with an illustrative embodiment of the present invention;

FIG. 7 is a diagram illustrating entries in a data structure for automatic detection of missing information in accordance with an illustrative embodiment of the present invention;

FIG. 8 is a flowchart of a process for analyzing an email message in accordance with an illustrative embodiment of the present invention;

FIG. 9 is a flowchart of a process for analyzing an email message using a template in accordance with an illustrative embodiment of the present invention; and

FIG. 10 is a flowchart of a process for analyzing an email message using automatic detection data in accordance with an illustrative embodiment of the present invention.

### DETAILED DESCRIPTION OF THE PREFERRED EMBODIMENT

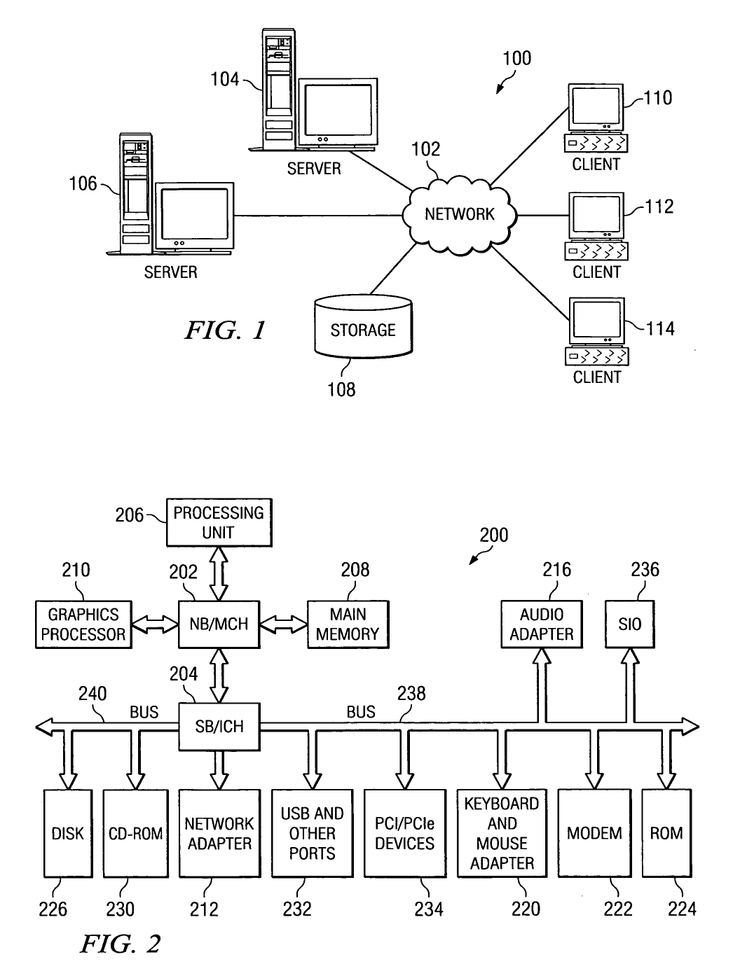

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pseries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention provide a computer implemented method, apparatus, and computer usable program code for preventing users from sending email messages before the messages are complete. A user is warned when an email message appears to be incomplete, and the user is provided an ability to complete the message if needed. The aspects of the present invention determine whether an email message appears to be incomplete. This determination may be made using a policy. A policy contains rules and other information used to determine whether an email message is complete. The policy may include a template that is configured by a user, as well as rules to determine whether the email message is complete. These rules may include, for example, rules to detect common phrases that indicate whether content or an attachment is to be expected, but is absent from the email message.

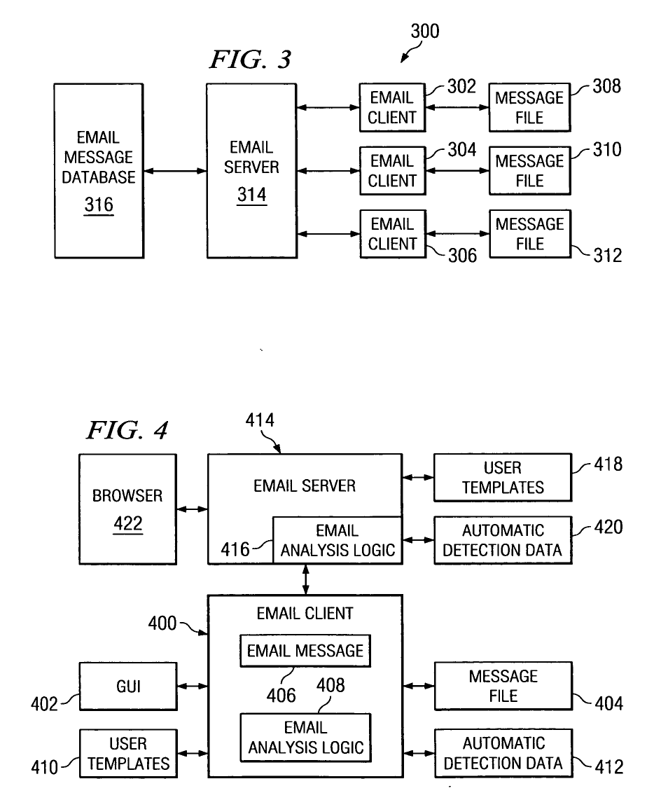

Turning now to FIG. 3, a diagram illustrating an exemplary electronic mail messaging system 300 is depicted in accordance with an illustrative embodiment of the present invention. In this example, email client 302, email client 304, and email client 306 are email clients, programs, or applications located at different client data processing systems, such as client 110, client 112, and client 114 in FIG. 1. Message file 308, message file 310, and message file 312 are associated with these email clients. These message files store email messages received by the clients and may be organized into various mailboxes. Examples of various mailboxes include, for example, an in folder, a sent folder, a deleted folder, and an outbox folder.

These email programs may employ different protocols depending upon the implementation. For example, simple mail transfer protocol (SMTP) is a standard email protocol that is based on TCP/IP. This protocol defines a message format and the message transfer agent which stores and forwards the mail. Other protocols, such as post office protocol 3 (POP3), also may be employed.

These email programs are used to send emails back and forth to different users through email server 314. Messages sent to other email clients are stored in email message database 316. When an email client connects to email server 314, any messages for that particular client are then sent to the client.

Email clients 302, 304, and 306 may be implemented using presently available email clients with an additional process or feature in which these clients now look for email type designation as described above.

With reference now to FIG. 4, a diagram illustrating components used to detect incomplete email messages is depicted in accordance with an illustrative embodiment of the present invention. These different components may be located on a data processing system, such as data processing system 200 in FIG. 2. Email client 400 is an example of an email client, such as email client 304 in electronic mail messaging system 300 in FIG. 3.

In this particular example, a user interacts with email client 400 using graphical user interface (GUI) 402. The user may read email messages received and stored in message file 404. Additionally, the user may create email messages through graphical user interface 402. When a user is ready to send email message 406, the user manipulates a control, such as a send button. In response, email client 400 activates email analysis logic 408 to determine whether email message 406 is complete.

Email analysis logic 408 analyzes email message 406 using a policy. In these examples, the policy includes user templates 410 and automatic detection data 412. User templates 410 contain rules that a user may generate to analyze email message 406. The user may select a particular template for use when email message 406 is generated. Alternatively, the template may be selected as a default or as part of sending the email message to the recipient.

The selected user template is used to analyze email message 406 to determine whether information is missing from email message 406. The missing information may be, for example, an attachment, such as a document. Additionally, email analysis logic 408 also may analyze email message 406 to determine whether information is missing that may not have been specified within a user template in user templates 410. Automatic detection data 412 is used for this type of analysis. This information includes phrases, keywords, and patterns that may be used to determine whether the email message indicates that information should be present that is not currently found in email message 406.

If email message 406 is incomplete, email client 400 presents this indication to the user through graphical user interface 402. At that time, the user may review email message 406 to determine whether the information should be added to email message 406. If information is to be added, the user then adds the information and then again requests sending email message 406. The analysis is again performed by email analysis logic 408. If email message 406 appears to be complete, the message is sent to the recipient or recipients. If email message 406 appears to still be incomplete, the user is provided with another alert through graphical user interface 402 in these examples. Of course, the user may determine that the alert is not justified and choose to send email message 406 without making changes.

Alternatively, the analysis of email message 406 may occur when the user sends email message 406 to email server 414 for delivery. When email server 414 receives email message 406, email analysis logic 416 may analyze email message 406 using user templates 418 and automatic detection data 420. Email analysis logic 416, user templates 418, and automatic detection data 420 are similar to those components described with respect to those associated with email client 400. In this manner, no changes are needed to email client 400 other than the ability to display messages when email message 406 is detected to be incomplete. This display can be implemented by returning email message 406 to the sender with instructions, and delaying sending of the email message to the recipient or recipients until the instructions are complete. In one implementation, the instructions can include resending email message 406 with any desired amendments. In this example, email server 414 accepts the resend with no further processing. This interaction between the server and client is similar to how some email systems handle invalid addressees. For example, IBM Lotus® Notes® returns the email to the sender allowing them to resend with an amended addressee list (To:, Cc:, Bcc:, etc.). Lotus® and Notes® are both registered trademarks of International Business Machines Corporation. In another implementation, the instructions can be sent via an email command within the protocol such as the current “return receipt request,” at which point email client 400 can take any desired action, such as, present the user with an alert. However, this implementation requires modification to email client 400 in order for it to understand the email protocol command and respond accordingly.

In this type of implementation, the email detection analysis and logic may be implemented as a service that may be provided to various email users through a central location, such as email server 414. As an example, Web based email messages generated through browser 422 may include this service in addition to more traditional email clients, such as email client 400.

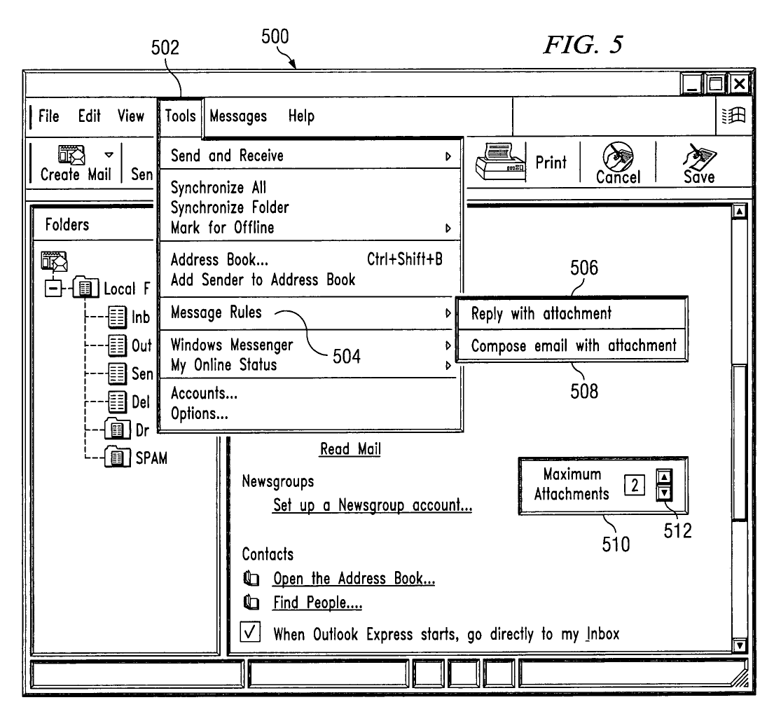

With reference now to FIG. 5, a diagram illustrating a graphical user interface for an email client is depicted in accordance with an illustrative embodiment of the present invention. In this example, window 500 illustrates a graphical user interface presented by an email client, such as graphical user interface 402 in FIG. 4. A menu, such as tools 502 is employed to present a dropdown list of a menu or menus, such as menu 504. Menu items 506 and 508 are displayed to the user from menu 504. Menu items 506 and 508 are items that are associated with templates that may be used to generate or analyze email messages. The user may select one of these menu items to start composing an email message. By selecting one of these templates, the email message will be analyzed using the rules associated with the identified template when the user requests to send the email message. Further, these templates also may be selected during or after the email message has been composed.

Additionally, window 500 also may include a pop-up or additional window, such as window 510. This window is displayed in this example if entry 506 is selected. This window allows the user to dynamically select the number of attachments for the email message. Control 512 allows the user to increase or decrease the number of attachments.

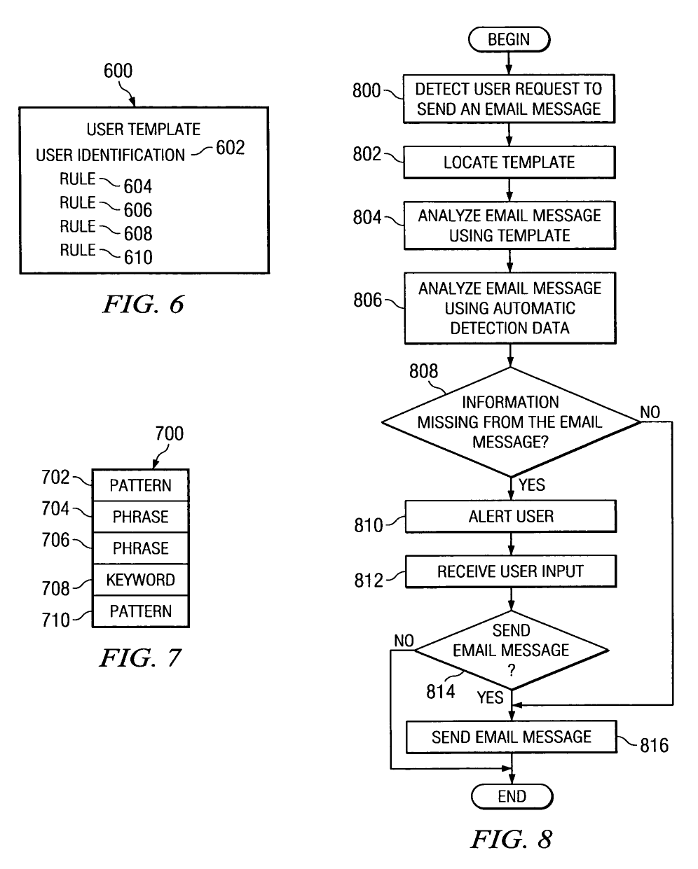

Turning now to FIG. 6, a diagram of a template is depicted in accordance with an illustrative embodiment of the present invention. Template 600 in this example is an example of a template found in user templates 410 or 418 in FIG. 4. Template 600 allows a user to define a menu item that appears in a menu within the email program to allow the user to select the template for use in generating email messages. This designation may be made through user identification 602. This identification may identify a menu item or button that is to be presented within the email program. For example, user identification 602 may be used to “reply with attachments” or “compose email with contact information”. User identification 602 may be implemented in the menu such that when the particular menu item is selected, the user identification is sent to the email analysis logic for use in identifying the user template that is to be used for analyzing the email message. In this manner, the user may generate an email message with this particular template by selecting the identification from a menu.

Additionally, template 600 includes user established rules. These rules may be established by the user, or pre-established as a default template or a template for selection by the user. In this example, template 600 contains rules 604, 606, 608, and 610. For example, rule 604 may specify that one document is to be attached. Additionally, the user may associate the template with a dialogue box to allow the user to specify on-the-fly the minimum number of attachments or the maximum attachment size for files. In this example, rule 606 may indicate that the attachment may be no larger than one megabyte.

If the template is for composing email messages with contact information, the user may specify specific words or patterns that must be included in the email message. For example, rule 604 may specify that a particular address, such as “1234 Main Street” is to be included. Additionally, even a pattern such as a set of numbers or an address may be specified in the rule to indicate that this information must be present in the email message prior to that message being sent. As another example, rule 608 may indicate that the following expression is to be present: [Mm]eet+at +[0-9A-Z]+at+(pm/am), which would look for a sentence such as “Meet me at McDonalds at 11:30 am” or “Lets meet with the customer at Chilis at 12 pm for lunch.”

Turning now to FIG. 7, a diagram illustrating entries in a data structure for automatic detection of missing information is depicted in accordance with an illustrative embodiment of the present invention. List 700 is a specific example of a data structure that may be used in automatic detection data 412 or 420 in FIG. 4. In this example, list 700 contains entries 702, 704, 706, 708, and 710. These entries contain patterns, phrases, and key words to determine whether an email message is complete.

For example, phrase 704 may be “attached is”, “attached are”, “I'm attaching”, or “the attached”. When the user requests to send the email message, the email analysis logic parses the text in the email message to determine whether these types of phrases are present using list 700. The phrases may be chosen as one that indicates that an attachment is required in this example. Other phrases that may be used for phrase 704 and 706 in list 700 are “I'm copying” or “I copied”. Another phrase is “graphic below” or “graphic above”. With the phrase “I am copying”, if an address is not present in the CC field, the email message is considered to be incomplete in this example.

With the indication that a graphic is present, if a graphic is not included in the email message as part of the body or as an attachment, then the email message is considered incomplete. Key words may be, for example, “attachment” used as a noun within the email message. In these examples, a pattern is an expression, such as ###-####, to indicate that a “pattern” of numbers with that format should be present in the email message.

With reference now to FIG. 8, a flowchart of a process for analyzing an email message is depicted in accordance with an illustrative embodiment of the present invention. The process illustrated in FIG. 8 may be implemented in a process within an email client, such as email analysis logic 408 in FIG. 4. This process also may be implemented in a server, such as email analysis logic 416 in email server 414 in FIG. 4.

The process begins by detecting a user request to send an email message (step 800). This request may be initiated by the user manipulating a graphic control, such as a send button in the email client. Thereafter, the template for the email message is located (step 802). This template may be selected by the user in initiating creation of the email message, while the email message is being composed, or even after the email message has been completed prior to the user deciding to send the email message. In these examples, the template is located in user templates 410 or 418 in FIG. 4. The process then analyzes the email message using the template (step 804). Next, the process analyzes the email message using automatic detection data (step 806). The automatic detection data may be automatic detection data 412 or 420 in FIG. 4.

A determination is made as to whether information is missing from the email message (step 808). This determination is made based on the results of the analysis in steps 804 and 806 in these examples. If information is not missing from the email message, the email message is considered to be complete. The process then sends the email message to the recipient or recipients (step 816) with the process terminating thereafter.

With reference again to step 808, if information is missing from the email message, the user is alerted (step 810). This alert may take various forms, such as a pop-up screen or message that is presented to the user. For example, the message may state “the text in the email message indicates that you may intend to include an attachment, but no attachment has been included. Click okay to send the email message without an attachment, or click cancel to cancel the sending and continue composing the email message”. The message may vary depending on the information missing or a more general message may be presented depending on the particular implementation.

Thereafter, input is received from the user (step 812). A determination is made as to whether the user has decided to send the email message (step 814). If the user has decided to send the email message, the process proceeds to step 816 as described above. Otherwise, the process terminates.

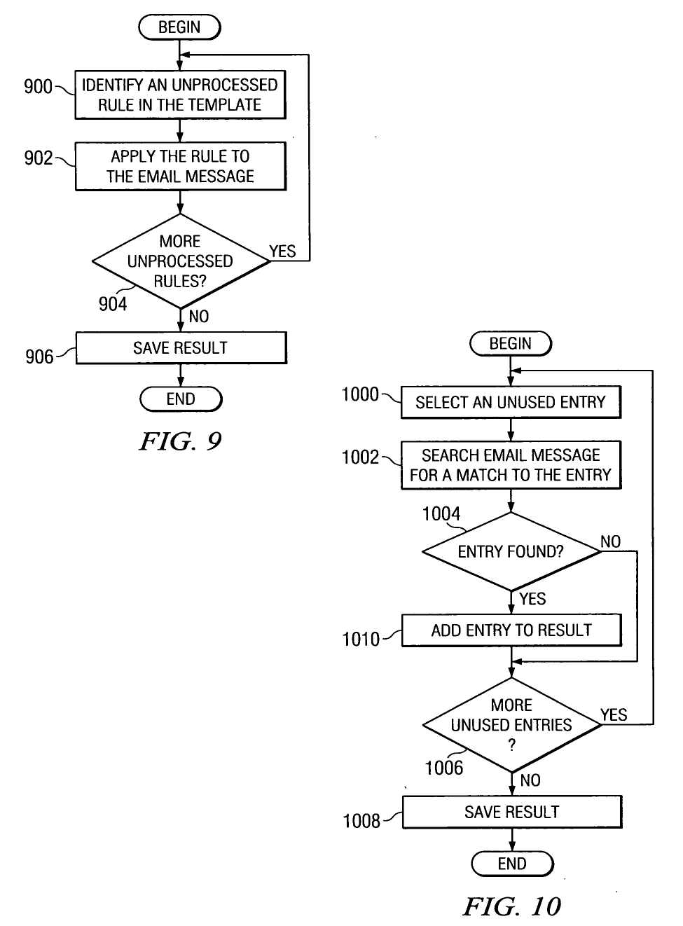

Turning next to FIG. 9, a flowchart of a process for analyzing an email message using a template is depicted in accordance with an illustrative embodiment of the present invention. The process illustrated in FIG. 9 is a more detailed description of step 804 in FIG. 8.

The process begins by identifying an unprocessed rule in the template (step 900). Thereafter, the rule is applied to the email message (step 902). A determination is made as to whether additional unprocessed rules are present in the template (step 904). If additional unprocessed rules are present, the process returns to step 900. Otherwise, the process saves the result of the analysis (step 906) with the process terminating thereafter. The result saved in step 906 are used to determine whether the email message should be sent, or whether the user should be alerted to the fact that the information is missing from the email message based on the analysis.

Turning next to FIG. 10, a flowchart of a process for analyzing an email message using automatic detection data is depicted in accordance with an illustrative embodiment of the present invention. The process illustrated in FIG. 10 is a more detailed description of step 806 in FIG. 8.

The process begins by selecting an unused entry in the automatic detection data (step 1000). The email message is searched for a match with the entry (step 1002). In these examples, the entry may be, for example, a keyword, a phrase, or a pattern as described above. The process selects an unused entry in step 1000 from a data structure, such as list 700 in FIG. 7.

Next, a determination is made as to whether the entry is found in the email message (step 1004). If the entry is not found, a determination is made as to whether additional unused entries are present in the list (step 1006). If additional unused entries are present, the process returns to step 1000. Otherwise, the result is saved (step 1008) with the process terminating thereafter. The result saved in step 1008 is used to determine whether the email message is complete and can be sent, or to send the user an indication that information may be missing from the email message. By saving the result in step 1008, the results do not necessarily need to be saved to some sort of persistent or permanent storage. Instead, this step may merely retain the results in memory for use.

With reference again to step 1004, if an entry is found in the email message, the entry is added to the result (step 1010) with the process then proceeding to step 1006 as described above.

Thus, the present invention provides a computer implemented method, apparatus and computer usable program code for determining whether an email message is complete. The aspects of the present invention allows for email pattern detection warning to identify email messages that are incomplete. In this manner, the identification of an incomplete email message allows a user the option to complete the email message before the email message is actually sent. The aspects of the present invention analyze the email message using a policy that includes templates and automatic detection data in these examples. If the email message is identified as being incomplete, the user is given the option to cancel the sending of the email message and add additional information to the email message or continue to send the email message.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for transmitting email messages, the computer implemented method comprising:
responsive to detecting a request to send an email message, analyzing the email message using a policy to form a result;
determining whether the result indicates that the email message is incomplete; and
generating an alert if a determination is present that indicates that the email message is incomplete.

2. The computer implemented method of claim 1 further comprising:
sending the email message to a recipient if a determination indicating that the email message is complete is present.

3. The computer implemented method of claim 1, wherein the policy comprises a template, wherein the template identifies user configured rules for analyzing the email message.

4. The computer implemented method of claim 3, wherein the policy further comprises at least one of key words, key phrases, and patterns for use in determining whether the email message is complete.

5. The computer implemented method of claim 1, wherein the analyzing step comprises:
determining whether selected information should be present using the policy; and
determining whether the selected information is present in the email message if the selected information should be present based on the policy.

6. The computer implemented method of claim 1, wherein the missing information comprises a file.

7. The computer implemented method of claim 6, wherein the missing information further comprises at least one of an address, a phone number, and a name.

8. A computer program product comprising:
a computer usable medium having computer usable program code for transmitting email messages, the computer program product including:
computer usable program code, responsive to detecting a request to send an email message, for analyzing the email message using a policy to form a result;
computer usable program code for determining whether the result indicates that the email message is incomplete; and
computer usable program code for generating an alert if a determination is present that indicates that the email message is incomplete.

9. The computer program product of claim 8 further comprising:
computer usable program code for sending the email message to a recipient if a determination indicating that the email message is complete is present.

10. The computer program product of claim 8, wherein the policy comprises a template, wherein the template identifies user configured rules for analyzing the email message.

11. The computer program product of claim 10, wherein the policy further comprises at least one of key words, key phrases, and patterns for use in determining whether the email message is complete.

12. The computer program product of claim 8, wherein the computer usable program code, responsive to detecting a request to send an email message, for analyzing the email message using a policy to form a result comprises:
computer usable program code for determining whether selected information should be present using the policy; and
computer usable program code for determining whether the selected information is present in the email message if the selected information should be present based on the policy.

13. The computer program product of claim 8, wherein the missing information comprises a file.

14. The computer program product of claim 13, wherein the missing information further comprises at least one of an address, a phone number, and a name.

15. A data processing system comprising:
a bus;
a communications unit connected to the bus;
a memory connected to the bus, wherein the storage device includes a set of computer usable program code; and
a processor unit connected to the bus, wherein the processor unit executes the set of computer usable program code to analyze the email message using a policy to form a result in response to detecting a request to send an email message; determine whether the result indicates that the email message is incomplete; and generate an alert if a determination is present that indicates that the email message is incomplete.

16. The data processing system of claim 15, wherein the processor unit further executes the computer usable code to send the email message to a recipient if a determination indicating that the email message is complete is present.

17. The data processing system of claim 15, wherein the processor unit further executes the computer usable code, wherein the policy comprises a template, and wherein the template identifies user configured rules for analyzing the email message.

18. The data processing system of claim 17, wherein the policy further comprises at least one of key words, key phrases, and patterns for use in determining whether the email message is complete.

19. The data processing system of claim 15, wherein the processor unit further executes the computer usable code to determine whether selected information should be present using the policy; and determine whether the selected information is present in the email message if the selected information should be present based on the policy.

20. The data processing system of claim 15, wherein the missing information comprises a file.
